(19) United States
(12) Patent Application Publication
(10) Pub. No.: US 2015/0025970 A1
(43) Pub. Date: Jan. 22, 2015

(54) Real Time Advertising Campaigns Utilizing Streaming Analytics Engines

(71) Applicant: Yahoo! Inc., Sunnyvale, CA (US)

(72) Inventor: Stuart OGAWA, Los Gatos, CA (US)

(21) Appl. No.: 13/945,732

(22) Filed: Jul. 18, 2013

(51) Int. Cl. G06Q 30/02

(52) U.S. Cl. CPC G06Q 30/0256
USPC 705/14.54

(57) ABSTRACT

The disclosure provides methods and systems for use in real time advertising campaigns and advertisement targeting. The systems sample streams of electronic data in real time. Sampled data may be analyzed and used to determine topics of interest. Sampled data may be analyzed or filtered to determine targeting data that includes a targeting keyword and a targeting user character. The systems may then launch a real time advertising campaign using the targeting data.

### BACKGROUND

Effectively spending advertising dollars, from the advertiser executive perspective, is a challenging problem. Furthermore, even an otherwise sound advertising campaign can be rendered ineffective by incorrect, delayed, or late to market timing, and even very small delays can render a campaign and its elements much less effective. This is particularly true as mobile devices, across the globe, are used to create and transmit real-time data. Mobile users may create and transmit data at a materially faster rate than existing advertising platforms can effectively intake, absorb, and process data in a timely, relevant and targeted manner, from a campaign perspective.

Current search engines perform deep refreshes of their indexing database approximately once a month (batch processing) with “trickle” feed (shallow) updates to the database. The current search engines systems cannot keep up with Twitter real time updates due to their current Hadoop/Map/Reduce batch processing approach. Thus, there is a need for more effective advertising techniques to address these issues.

### SUMMARY

Some embodiments of the disclosure provide systems and methods for use in real time advertising campaigns, including advertisement targeting using real time data sensing, sampling, and detecting methods applied to data being created and/or data in transit. The systems sample streams of electronic data in real time. Sampled data may be analyzed and used to determine topics of interest. Sampled data may be analyzed or filtered to determine targeting data that includes a targeting keyword and a targeting user character. The systems may then launch a real time advertising campaign using the targeting data.

### BRIEF DESCRIPTION OF THE DRAWINGS

FIG. 1 is an example computer system according to one embodiment of the disclosure;

FIG. 2 is an example flow diagram illustrating a method according to one embodiment of the disclosure;

FIG. 3 is an example flow diagram illustrating a method according to one embodiment of the disclosure; and

FIG. 4 is an example block diagram illustrating one embodiment of the disclosure.

### DETAILED DESCRIPTION

Throughout the specification and claims, terms may have nuanced meanings suggested or implied in context beyond an explicitly stated meaning Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

The term “social network” refers generally to a network of individuals, such as acquaintances, friends, family, colleagues, or co-workers, coupled via a communications network or via a variety of sub-networks. Potentially, additional relationships may subsequently be formed as a result of social interaction via the communications network or sub-networks. A social network may be employed, for example, to identify additional connections for a variety of activities, including, but not limited to, dating, job networking, receiving or providing service referrals, content sharing, creating new associations, maintaining existing associations, identifying potential activity partners, performing or supporting commercial transactions, or the like.

A social network may include individuals with similar experiences, opinions, education levels or backgrounds. Subgroups may exist or be created according to user profiles of individuals, for example, in which a subgroup member may belong to multiple subgroups. An individual may also have multiple “1:few” associations within a social network, such as for family, college classmates, or co-workers.

An individual's social network may refer to a set of direct personal relationships or a set of indirect personal relationships. A direct personal relationship refers to a relationship for an individual in which communications may be individual to individual, such as with family members, friends, colleagues, co-workers, or the like. An indirect personal relationship refers to a relationship that may be available to an individual with another individual although no form of individual to individual communication may have taken place, such as a friend of a friend, or the like. Different privileges or permissions may be associated with relationships in a social network. A social network also may generate relationships or connections with entities other than a person, such as companies, brands, or so-called ‘virtual persons.’ An individual's social network may be represented in a variety of forms, such as visually, electronically or functionally. For example, a “social graph” or “socio-gram” may represent an entity in a social network as a node and a relationship as an edge or a link.

In the information age and current economy, there is a need to launch automated, “first to advertise” campaigns well in advance of its competitors. This disclosure describes a novel computer system and method to facilitate low to zero latency automated advertising campaigns using real time data sensing, sampling, and detecting methods applied to data being created and or data in transit.

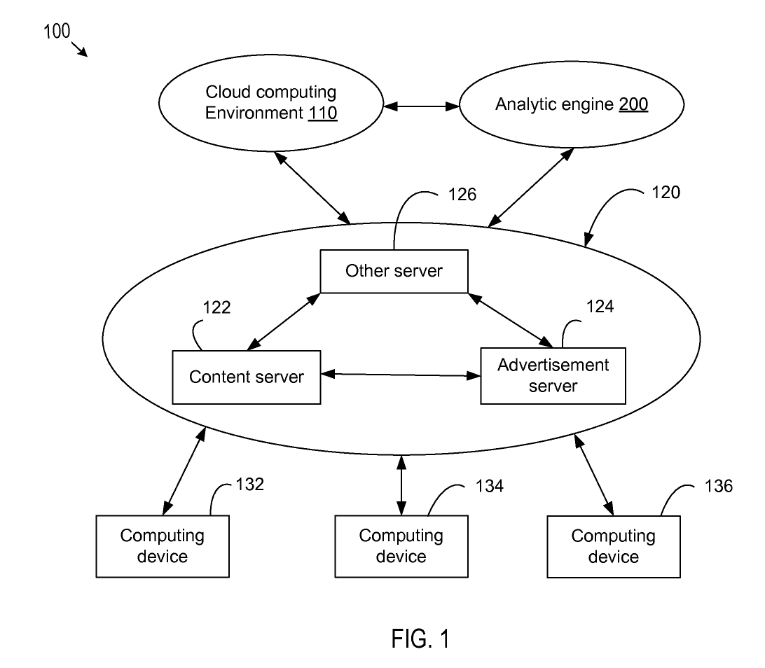

FIG. 1 shows an example computer system 100 for real time advertising campaigns. The computer system 100 may include a cloud computing environment 110 and a connected server system 120 including a content server 122, an advertisement server 124, and other server 126. The disclosed method and system may be implemented in the cloud computing environment 110 or the server system 120. A server may include a computing device may be capable of sending or receiving signals, such as via a wired or wireless network, or may be capable of processing or storing signals, such as in memory as physical memory states. Thus, a server device may include, as examples, dedicated rack mounted servers, desktop computers, laptop computers, set top boxes, integrated devices combining various features, such as two or more features of the foregoing devices, or the like.

Servers may vary widely in configuration or capabilities, but generally a server may include one or more central processing units and memory. A server may also include one or more mass storage devices, one or more power supplies, one or more wired or wireless network interfaces, one or more input/output interfaces, or one or more operating systems, such as Windows Server, Mac OS X, Unix, Linux, FreeBSD, or the like.

The content server 122 may include a device that includes a configuration to provide content via a network to another device. A content server may, for example, host a site, such as a social networking site, examples of which may include, without limitation, Flicker, Twitter, Facebook, LinkedIn, or a personal user site (such as a blog, vlog, online dating site, etc.). A content server may also host a variety of other sites, including, but not limited to business sites, educational sites, dictionary sites, encyclopedia sites, wikis, financial sites, government sites, etc.

A content server may further provide a variety of services that include, but are not limited to, web services, third-party services, audio services, video services, email services, instant messaging (IM) services, SMS services, MMS services, FTP services, voice over IP (VOIP) services, calendaring services, photo services, or the like. Examples of content may include text, images, audio, video, or the like, which may be processed in the form of physical signals, such as electrical signals, for example, or may be stored in memory, as physical states, for example.

The advertisement server 124 may be a computer system, one or more servers, or any other computing device known in the art, or the advertisement server 124 may be a computer program, instructions and/or software code stored on a computer-readable storage medium that runs on a processor of a single server, a plurality of servers, or any other type of computing device known in the art. The advertisement server 124 may be configured to provide digital ads to a web user based on display conditions requested by the advertiser. The advertisement server 124 may be configured to provide LBS related ads when a location related webpage is displayed or a location related search query is received by a search engine.

Other server 126 may be, for example, a search engine. The search engine may be a computer system, one or more servers, or any other computing device known in the art, or the search engine may be a computer program, instructions, and/or software code stored on a computer-readable storage medium that runs on a processor of a single server, a plurality of servers, or any other type of computing device known in the art. The search engine may be configured to help users find information located on the Internet or an intranet. In addition, the search engine may also provide LBS to anyone if certain search queries are received.

The cloud computing environment 110 and the connected server system 120 have access to an analytic engine 200. The analytic engine 200 may be a separate computer system as illustrated in FIG. 1. The analytic engine 200 may be configured to receive data from the server system 120 and select electronic advertisements for serving in real time based on real time data analysis on the received data. Alternatively or additionally, the analytic engine 200 may be implemented partially in any of the above servers in the server system 120.

The computer system 100 may further include a plurality of client devices 132, 134, and 136. The client device may include a computing device capable of sending or receiving signals, such as via a wired or a wireless network. A client device may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like.

The client device may vary in terms of capabilities or features. For example, a cell phone may include a numeric keypad or a display of limited functionality, such as a monochrome liquid crystal display (LCD) for displaying text. In contrast, however, as another example, a web enabled client device may include one or more physical or virtual keyboards, mass storage, one or more accelerometers, one or more gyroscopes, global positioning system (GPS) or other location identifying type capability, or a display with a high degree of functionality, such as a touch sensitive color 2D or 3D display, for example.

The client device may include or may execute a variety of operating systems, including a personal computer operating system, such as a Windows, iOS or Linux, or a mobile operating system, such as iOS, Android, or Windows Mobile, or the like. A client device may include or may execute a variety of possible applications, such as a client software application enabling communication with other devices, such as communicating one or more messages, such as via email, short message service (SMS), or multimedia message service (MMS), including via a network, such as a social network, including, for example, Facebook, LinkedIn, Twitter, Flickr, or Google+, to provide only a few possible examples. A client device may also include or execute an application to communicate content, such as, for example, textual content, multimedia content, or the like. A client device may also include or execute an application to perform a variety of possible tasks, such as browsing, searching, playing various forms of content, including locally stored or streamed video, or games (such as fantasy sports leagues). The foregoing is provided to illustrate that claimed subject matter is intended to include a wide range of possible features or capabilities.

Generally, a web user or any other user may use a client device to access information on the server system 120. For example, an advertiser may purchase digital ads based on an auction model of buying ad space or a guaranteed delivery model by which an advertiser pays a minimum cost per thousand ads displayed (“CPM”) to display the digital ad. When a user click on the digital ad, the client device may load a web page related to the advertiser.

For example, when a user utilizes one of the client devices 132, 134, 136 to submit user created content to the content server 122, the content server 122 may send a copy of the user created content to the analytic engine 200. The analytic engine 200 may additionally communicate with the advertisement server 124 to receive target data. In addition or alternatively, the analytic engine 200 may sample, in real time, one or more streams of electronic data from any server in the computer server system 120, the electronic data comprising user generated content from one or more user devices, to obtain sample data. The analytic engine 200 is configured to analyze, in real time, the sample data to obtain targeting data, wherein the targeting data comprises data relating to at least one of a targeting keyword or a targeting user character. The target keyword or target user character may be obtained from the advertisement server 124 or a database. Based on the analysis result, the analytic engine 200 launches a real time advertisement campaign.

In a social network example, the content server 122 receives a number of messages such as blogs or tweets about a football game right after the game is over. The analytic engine 200 analyzes the data of these messages and finds target data related to a target keyword. The target data may include the most frequently used words, the most tweeted keywords, the city names, brand names, athlete names, or any other keywords. Additionally or alternatively, the analytic engine 200 may analyze the user profiles of all these messages and find a number of users having a targeting user character. After analyzing the sampled data about the football game, the analytic engine 200 may launch an advertisement campaign if the number of messages including the target keyword is greater than a first predetermined threshold number or if the number of users having the targeting user character is greater than a second predetermined threshold number. The threshold numbers may be an absolute number such as 10,000 or a percentage such as 40%.

The analytic engine 200 may further identify targeting devices based on the user generated data or their user profiles if the users viewed or contributed to a hot topic related to the football game. The analytic engine 200 may send the information about the targeting devices to the advertisement server 126 so that the advertisement server 126 may determine whether to launch a real time advertisement campaign on those targeting devices.

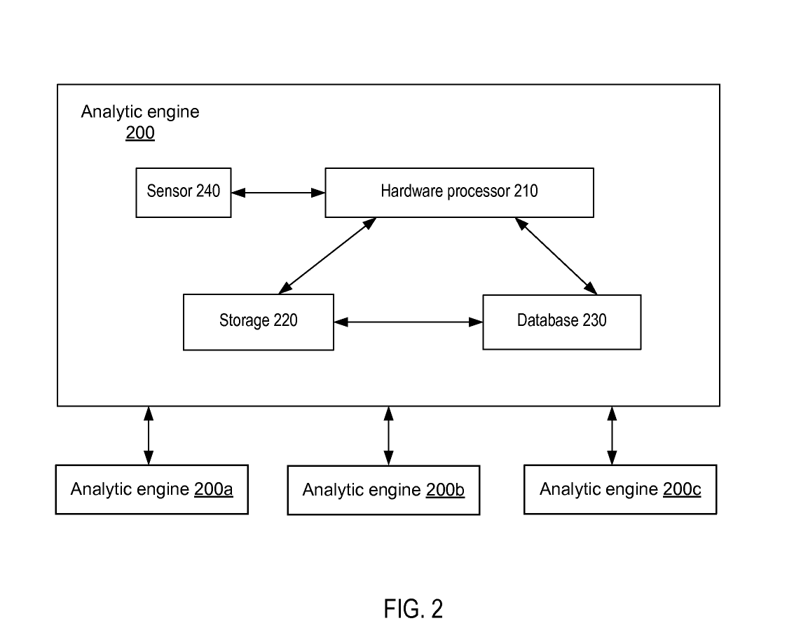

FIG. 2 illustrates an example of an advertisement system including an analytic engine 200. The analytic engine 200 includes a hardware processor 210 connected to a storage 220. The analytic engine 200 may further include a database 230 and a sensor 240. The storage 220 may include non-transitory storage such as read-only memory (ROM), a hard disk, a compact disc, or any other storage medium known in the art. The database 230 may be accessed by the hardware processor 210 and may be partially stored in the storage 220. The sensor 240 may be configured to sense and/or sample electronic data transmitted in a network system. The sensor 240 may be connected to any servers in FIG. 1 or any data transmitting interfaces such as network switches, network gateways, or cell towers. The analytic engine 200 may be placed anywhere in the data creation, data intermediary, and data transmission, data processing, and data recipient processing chain.

The advertisement system may include a plurality of analytic engines 200a, 200b and 200c. The analytic engines may be placed in a number of locations where a central controlling system can monitor all real time systems to perform massive and scalable data detection to launch campaigns. In one embodiment, the central controlling system may be the analytic engine 200. This improves early data detection, data accuracy, and improves global campaign targeting.

For example, the advertisement system may include a first analytic engine in a social network site, a second analytic engine in a traditional news webpage, and a third analytic engine in a mobile application running in a smartphone or other mobile devices. The analytic engines are configured to identify real time gaps in global communication, known as imperfect information distribution gaps, and exploit these gaps to an advertiser's first move advantage.

The analytic engines 200, 200a, 200b, and 200c intelligently analyze data collected from sensors, including but not limited to streaming analytic sensors (SAS) disclosed in U.S. patent application Ser. No. 13/283,091. The advertisement system is configured to launch automated advertising campaigns without human intervention and at near 0 to low latency response times. This enables advertisers to launch first to advertise campaigns, which can lead to higher sales revenue.

The real time analytic engines are configured to perform intelligent processing including, but not limited to:

1. storing data points captured by SAS, performing business actions based on specific data points, and performing real time actions based on data volume, data types, metadata, time, text, geo, to name a few;

2. storing data points captured by SAS, applying algorithms (matching algorithms, pattern algorithms, etc.) against stored and analyzed data points, and performing real time business actions based upon the algorithm results;

3. storing data points captured by SAS, applying predict/forecasting models against stored data points, and performing real time business actions using predict and forecast-like models;

4. storing data points captured by SAS, applying meta data to captured data, (1), (2), and (3) aforementioned options (either singularly or in plurality) and consequently performing business actions;

5. storing data points captured by SAS, applying text, video, voice analytics against captured data, and performing business actions as a result of the text, video, etc. analytic results;

6. each of the aforementioned analytic engines (1), (2), (3), (4), and (5) can be used individually or in any combination resulting in single or several analytic engines running concurrently real time with the SAS; and

7. the processing in (6) can be used in conjunction with a single or a plurality of SAS systems.

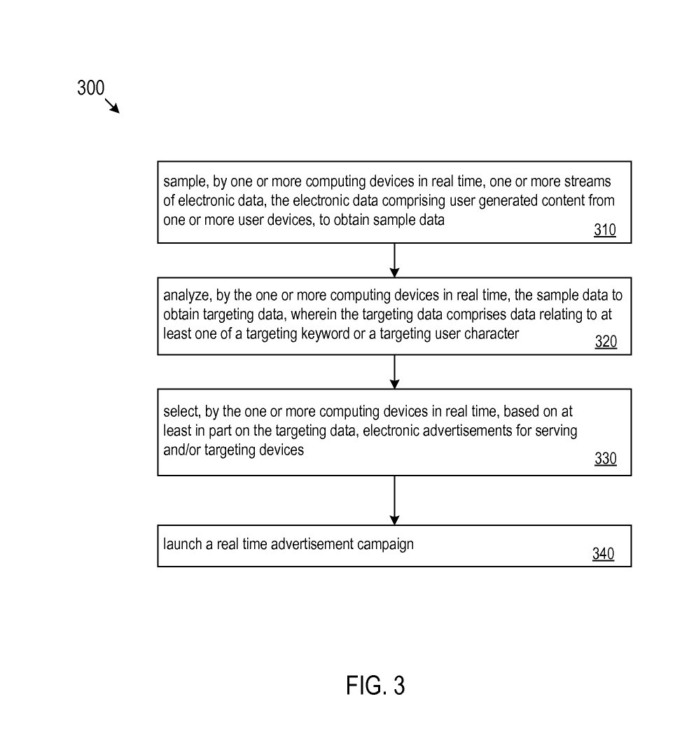

FIG. 3 is an example flow diagram 300 illustrating a method according to one embodiment of the disclosure. The method may be implemented in a computer system illustrated in FIG. 1. Additionally or alternatively, the method may be implemented in a plurality of analytic engines illustrated in FIG. 2. An example of the computer implemented method may include the following steps. Other steps may be added or substituted.

In step 310, a computing device samples, in real time, one or more streams of electronic data. The electronic data comprising user generated content from one or more user devices, to obtain sample data. For example, the computing device may monitor, in multiple geographical locations, one or more streams of electronic data during data transmission in a network or when the data is generated. The computing devices may sample and analyze data in multiple geographical locations during at least one of the following stages: data creation; data intermediary; data transmission; data processing; and data reception.

In step 320, the computing device analyzes, in real time, the sample data to obtain targeting data, where the targeting data includes data relating to at least one of a targeting keyword or a targeting user character. The targeting keyword and targeting user character may be preselected or stored in an advertisement server or a database.

In step 330, the computing device selects, in real time, based on at least in part on the targeting data, electronic advertisements for serving and/or targeting devices. The computing device may adopt predict/forecasting models against sampled data points. The computing device may use matching algorithms, pattern recognition algorithms, or other algorithms to analyze the data and select the electronic advertisements.

In step 340, the computing device launches a real time advertisement campaign based on the targeting data. For example, the computing device may launch the real time advertisement campaign by serving at least one of the selected electronic advertisements on at least one of the targeting devices in real time.

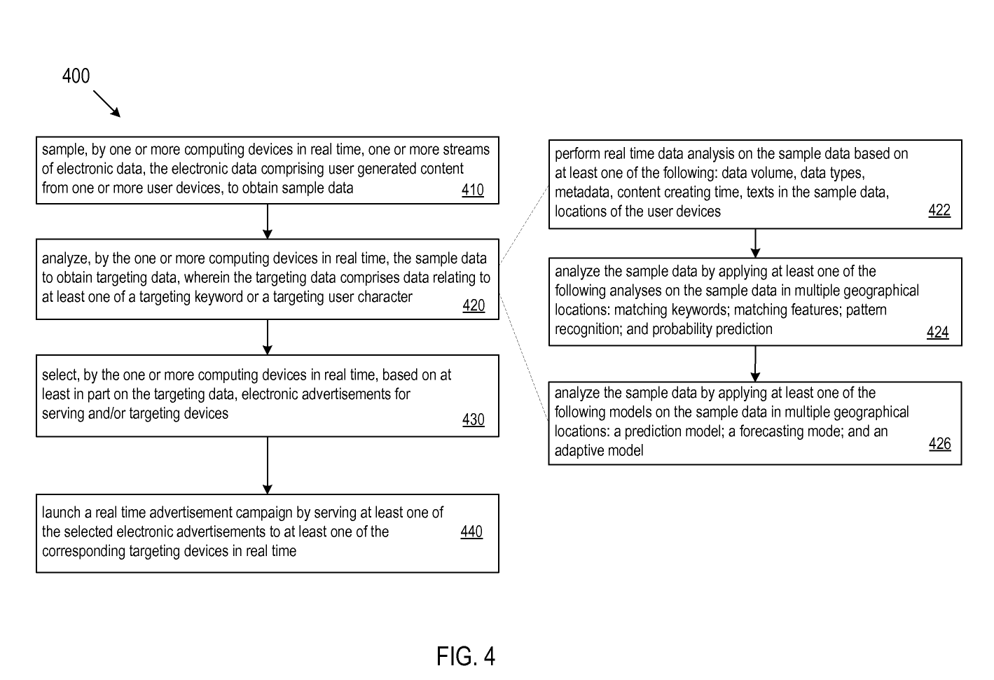

FIG. 4 is an example block diagram 400 illustrating one embodiment of the disclosure. Steps 410, 420, and 430 are similar to steps 310, 320, and 330 in the block diagram in FIG. 3,

Additionally, step 420 may include at least one of the steps in 422, 424, or 426. In step 422, the computing device analyzes the sample data by performing real time data analysis on the sample data based on at least one of the following: data volume, data types, metadata, content creating time, texts in the sample data, and locations of the user devices.

In step 424, computing device analyzes the sample data by applying at least one of the following analyses on the sample data in multiple geographical locations: matching keywords; matching features; pattern recognition; and probability prediction

In step 426, computing device analyzes the sample data by applying at least one of the following models on the sample data in multiple geographical locations: a prediction model; a forecasting mode; and an adaptive model

In step 440, the computing device launches a real time advertisement campaign on the selected targeting devices based on the targeting data. For example, the computing device may launch the real time advertisement campaign by serving at least one of the selected electronic advertisements on at least one of the targeting devices in real time.

The proposed system and methods enable advertisers to increase topline revenue by creating campaigns at the speed of user data creation and transmission, as opposed to waiting for the data to be received by a publisher. The disclosed system performs analytics in order to gain insights, and then launch campaigns in real time and without human intervention. Thus, the system introduces first mover advertiser opportunities and increased revenue.

Using the disclosed systems and methods, publishers and content providers can sell premium “first to act” service levels and increase revenue and differentiating themselves from competitors. The disclosed system reduces the time it takes for publishers and content providers to gain insights and consequently provide premium information services which command premium incremental revenue streams. Further, the system is unique in that is can be implemented, in various topology embodiments, to globally scale into an integrated number installations such as cell towers, publishers and content provider servers, clouds, data centers, and others.

While the disclosure is described with reference to the above drawings, the drawings are intended to be illustrative, and the disclosure contemplates other embodiments within the spirit of the disclosure.

What is claim is:

1. A system comprising a server having a hardware processor and a non-transient storage medium accessible to the hardware processor; wherein the system is configured to:
sample, in real time, one or more streams of electronic data, the electronic data comprising user generated content from one or more user devices, to obtain sample data;
analyze, in real time, the sample data to obtain targeting data, wherein the targeting data comprises data relating to at least one of a targeting keyword or a targeting user character; and
launch a real time advertisement campaign based on the targeting data.

2. The system of claim 1, wherein the system is further configured to select electronic advertisements for serving in real time based on at least in part on the targeting data.

3. The system of claim 2, wherein the system is further configured to select targeting devices from the one or more user devices in real time based on at least in part on the targeting data.

4. The system of claim 3, wherein the system launches the real time advertisement campaign by serving at least one of the selected electronic advertisements on at least one of the targeting devices in real time.

5. The system of claim 1, wherein the system is further configured to store the sample data in the non-transient storage medium.

6. The system of claim 1, wherein the system is further configured to analyze the sample data by applying at least one of the following analyses on the sample data in multiple geographical locations: matching keywords; matching features; pattern recognition; and probability prediction.

7. The system of claim 1, wherein the system is further configured to analyze the sample data by applying at least one of the following models on the sample data in multiple geographical locations: a prediction model; a forecasting mode; and an adaptive model.

8. The system of claim 1, wherein the system is configured to sample and analyze data in multiple geographical locations during at least one of the following stages: data creation;
data intermediary; data transmission; data processing; and data reception.

9. A method comprising:
sampling, by one or more computing devices in real time, one or more streams of electronic data, the electronic data comprising user generated content from one or more user devices, to obtain sample data;
analyzing, by the one or more computing devices in real time, the sample data to obtain targeting data, wherein the targeting data comprises data relating to at least one of a targeting keyword or a targeting user character;
selecting, by the one or more computing devices in real time, based on at least in part on the targeting data, electronic advertisements for serving and targeting devices; and
launching a real time advertisement campaign.

10. The method of claim 9, further comprising: storing the sample data based on the targeting data.

11. The method of claim 9, wherein analyzing the sample data comprises: performing real time data analysis on the sample data based on at least one of the following: data volume, data types, metadata, content creating time, texts in the sample data, and locations of the user devices.

12. The method of claim 9, wherein sampling comprises monitoring, in multiple geographical locations, one or more streams of electronic data during data transmission.

13. The method of claim 9, wherein launching the real time advertisement campaign comprising serving at least one of the selected electronic advertisements to at least one of the targeting devices in real time.

14. The method of claim 9, further comprising: analyzing the sample data by applying at least one of the following analyses on the sample data in multiple geographical locations:
matching keywords; matching features; pattern recognition; and probability prediction.

15. The method of claim 9, further comprising: analyzing the sample data by applying at least one of the following models on the sample data in multiple geographical locations: a prediction model; a forecasting mode; and an adaptive model.

16. The method of claim 9, wherein the one or more computing devices sample and analyze data in multiple geographical locations during at least one of the following stages: data creation; data intermediary; data transmission; data processing; and data reception.

17. A non-transitory storage medium configured to store a set of instructions, the set of instructions to direct a computer system to perform acts of:
sampling, by one or more computing devices in real time, one or more streams of electronic data, the electronic data comprising user generated content from one or more user devices, to obtain sample data;
analyzing, by the one or more computing devices in real time, the sample data to obtain targeting data, wherein the targeting data comprises data relating to at least one of a targeting keyword and a targeting user character;
selecting, by the one or more computing devices in real time, based on at least in part on the targeting data, electronic advertisements for serving and targeting devices; and
launching a real time advertisement campaign.

18. The non-transitory storage medium of claim 17, wherein the set of instructions to direct the computer system to monitor, in multiple geographical locations, one or more streams of electronic data during data transmission.

19. The non-transitory storage medium of claim 17, wherein launching the real time advertisement campaign comprising serving at least one of the selected electronic advertisements to at least one of the corresponding targeting devices in real time.

20. The non-transitory storage medium of claim 17, wherein the streams of data comprises at least one of the following data: voice data, video data, chatting history data, audio data, gaming data, social network data, photos; and blog data.
